(19) United States
(12) Patent Application Publication
(10) Pub. No.: US 2018/0307203 A1
(43) Pub. Date: Oct. 25, 2018

(54) MACHINING DEFECT FACTOR ESTIMATION DEVICE

(71) Applicant: FANUC Corporation, Yamanashi (JP)

(72) Inventors: Nobuaki AIZAWA, Yamanashi (JP); Tomokazu KAYANUMA, Yamanashi (JP)

(21) Appl. No.: 15/956,876

(22) Filed: Apr. 19, 2018

(30) Foreign Application Priority Data
Apr. 20, 2017 (JP) 2017-084032

(51) Int. Cl. G05B 19/408; G05B 13/02; G05B 19/402; G05B 19/4065

(52) U.S. Cl. CPC G05B 19/4083; G05B 13/0265; G05B 2219/37245; G05B 19/4065; G05B 2219/49061; G05B 19/402

(57) ABSTRACT

A machining defect factor estimation device includes a machine learning device that learns an occurrence factor of a machined-surface defect based on an inspection result on a machined surface of a workpiece. The machine learning device observes the inspection result on the machined surface of the workpiece from an inspection device, as a state variable, acquires label data indicating the occurrence factor of the machined-surface defect, and learns the state variable and the label data in a manner such that they are correlated each other.

### BACKGROUND OF THE INVENTION

### 1. Field of the Invention

The present invention relates to a machining defect factor estimation device and particularly relates to a technique for estimating an occurrence factor of defect on a machined surface of a workpiece.

### 2. Description of the Related Art

Conventionally, machining programs have been produced and materials have been machined by control over machine tools based on the machining programs, so that workpieces such as components and dies have been produced. For workpieces produced in such a manner, quality of machined surfaces has been determined based on various evaluation items that can be observed by laser microscopes or various features that can be acquired from photographed images. In case where a defect has occurred on a machined surface, data from various sensors provided in the machine tool is checked and an occurrence cause of the defect is identified by trial and error. Accordingly, improvements for preventing occurrence of similar defects are carried out.

In Japanese Patent Application Laid-Open No. 2017-68325, for instance, a method is described in which an optimal speed distribution with a balance between the machined surface quality and machining time may be found through machine learning with use of vibration data for a machine tool. This method makes it possible to control the machine tool so that the machine tool may carry out machining at such an appropriate machining speed as to curb occurrence of a defect on a machined surface.

The quality of a machined surface is influenced by diverse factors. FIG. 8 illustrates various processes relating to machining of a workpiece. Initially, a machining program is produced through CAD/CAM. A CNC (numerical controller) interprets the machining program and thereby carries out acceleration-deceleration control. A manner of the acceleration-deceleration control is an element that influences the quality of a machined surface. Subsequently, servo control is carried out, so that machining is executed by a machine tool. A manner of the servo control, machine vibrations and peripheral device vibrations that occur in process of the machining, machining conditions, states of tools and cutting fluid, and the like are other elements that influence the quality of a machined surface.

Conventionally, a large number of sensors are provided in a machine tool and data is collected from the sensors, for detection of states of various elements that may be factors of such a machined-surface defect as described above. Upon occurrence of a defective workpiece, the data from the sensors is checked and a problematic element is thereby identified. It is often impossible to identify a defective workpiece from the sensor data and then a skilled operator estimates the problematic element based on experience.

In such a conventional method, however, sensors have to be provided in all the elements that may influence the quality of a machined surface, for each machine or each cell. When a defect occurs on a machined surface in this method, all the data from each sensor has to be checked. Furthermore, use of such a large number of sensors entails maintenance work for each sensor itself and the like. Such work is extremely troublesome. In case of a failure in identification from the sensor data, a skilled operator estimates the problematic element by relying mostly on experience and thus there is a problem in that a less-experienced operator may be incapable of identifying the problematic element.

### SUMMARY OF THE INVENTION

The invention has been produced in order to solve above problems. An object of the invention is to provide a machining defect factor estimation device that is capable of estimating an occurrence factor of defect on a machined surface of a workpiece.

A first mode of a machining defect factor estimation device according to the invention determines an occurrence factor of a machined-surface defect, based on an inspection result on a machined surface of a workpiece from an inspection device and includes a machine learning device that learns the occurrence factor of the machined-surface defect which corresponds to the inspection result from the inspection device. The machine learning device includes a state observation unit that observes the inspection result on the machined surface of the workpiece from the inspection device, as a state variable, a label data acquisition unit that acquires label data indicating the occurrence factor of the machined-surface defect, and a learning unit that learns the state variable and the label data in a manner such that they are correlated each other.

The learning unit may include an error calculation unit that calculates an error between a correlation model for determination on the occurrence factor of the machined-surface defect from the state variable and a correlation characteristic identified from teacher data prepared in advance and a model update unit that updates the correlation model so as to reduce the error.

The learning unit may carry out calculations of the state variable and the label data in a multi-layer structure.

The machining defect factor estimation device may further include a determination output unit that outputs the occurrence factor of the machined-surface defect which is determined based on a result of learning by the learning unit. The determination output unit may output a warning in case where the occurrence factor of the machined-surface defect that is determined by the learning unit complies with a preset condition.

The inspection result on the machined surface of the workpiece from the inspection device may be a value acquired with use of at least one of surface roughness Sa, surface maximum height Sv, a surface texture aspect ratio Str, kurtosis Sku, skewness Ssk, developed interfacial area ratio Sdr, light reflectance, and an image feature of the workpiece.

The inspection device may be made to carry out a predetermined operation for the determination on the occurrence factor of the machined-surface defect by the learning unit. The predetermined operation for the determination may be carried out automatically or in response to a request from an operator.

The machining defect factor estimation device may be configured as a portion of the inspection device.

The machining defect factor estimation device may be configured as a portion of a management device that manages a plurality of the inspection devices through a network.

A second mode of a machining defect factor estimation device according to the invention determines an occurrence factor of a machined-surface defect, based on an inspection result on a machined surface of a workpiece from an inspection device and includes a model that represents a correlation between the inspection result on the machined surface of the workpiece from the inspection device and label data that indicates the occurrence factor of the machined-surface defect and a determination output unit that outputs the occurrence factor of the machined-surface defect which is determined based on the model.

According to the invention, the machining defect factor estimation device that enables estimation of an occurrence factor of defect on a machined surface of a workpiece can be provided.

### BRIEF DESCRIPTION OF THE DRAWINGS

FIG. 1 is a schematic functional block diagram illustrating a machining defect factor estimation device according to a first embodiment of the invention.

FIG. 2 is a schematic functional block diagram illustrating a mode of the machining defect factor estimation device.

FIG. 3A is a diagram illustrating neurons.

FIG. 3B is a diagram illustrating a neural network.

FIG. 4 is a schematic functional block diagram illustrating a machining defect factor estimation device according to a second embodiment of the invention.

FIG. 5 is a schematic functional block diagram illustrating a mode of a machining defect factor estimation system.

FIG. 6 is a schematic functional block diagram illustrating another mode of the machining defect factor estimation system.

FIG. 7 is a schematic functional block diagram illustrating a mode of a machining defect factor estimation system that includes a management device.

FIG. 8 is a diagram illustrating a conventional machining defect factor estimation method.

### DETAILED DESCRIPTION OF THE PREFERRED EMBODIMENTS

Hereinbelow, a configuration example of a machining defect factor estimation device that is an embodiment of the invention will be described. A configuration of the machining defect factor estimation device of the invention, however, is not limited to the example below and any configuration may be employed as long as the configuration may attain the object of the invention.

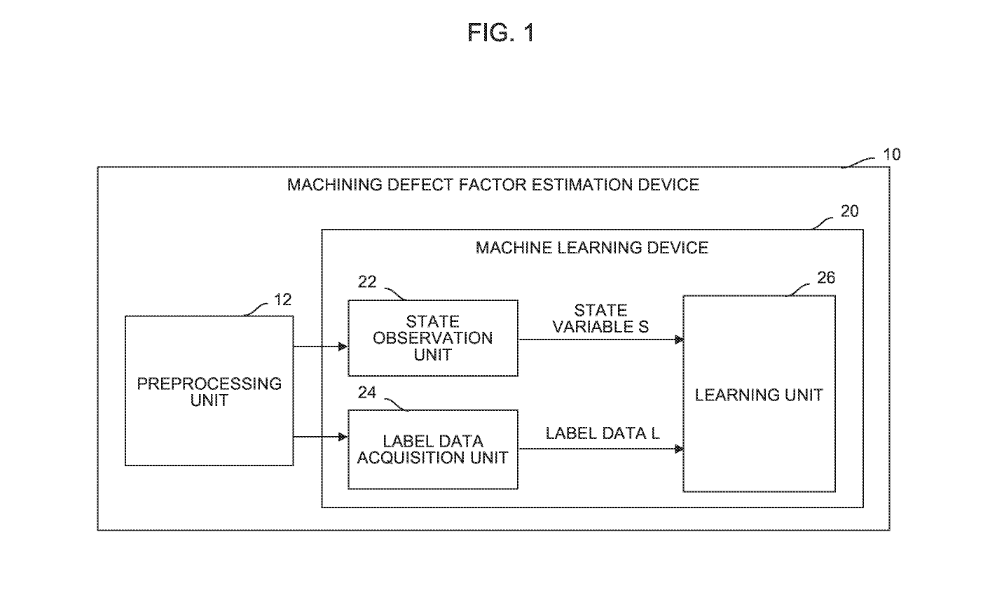

FIG. 1 is a functional block diagram illustrating a schematic configuration of a machining defect factor estimation device 10 that is the embodiment of the invention.

The machining defect factor estimation device 10 may be implemented as a computer or the like that is connected via a wired or wireless communication line to an inspection device (not illustrated) for machined workpieces so as to be capable of carrying out data communication, for instance. Though the inspection device may be a machined surface analyzer (typically, a laser microscope), a machined surface imaging unit, optical reflectance measuring equipment, or the like, for instance, the inspection device is not limited to those.

The machining defect factor estimation device 10 includes a preprocessing unit 12 that performs preprocessing for data acquired from the inspection device and a machine learning device 20 that includes software (such as a learning algorithm) and hardware (such as a CPU of a computer) for self-learning on factors in machined-surface defects through so-called machine learning. The factors in the machined-surface defects that are learned by the machine learning device 20 correspond to a model structure that represents a correlation between inspection results (numerical data acquired from the inspection device) obtained when the inspection device inspects workpieces on which the machined-surface defects have occurred and data indicating the factors in such machining defects.

As illustrated by functional blocks in FIG. 1, the machine learning device 20 included in the machining defect factor estimation device 10 includes a state observation unit 22 that observes the numerical data indicating an inspection result on a machined-surface defective workpiece acquired from the inspection device (not illustrated), as a state variable S representing a current state of an environment, a label data acquisition unit 24 that acquires label data L indicating a factor in a machining defect in the workpiece, and a learning unit 26 that learns the label data L associated with the state variable S.

The preprocessing unit 12 may be configured as a function of a CPU of a computer or may be configured as software for making a CPU of a computer function, for instance. The preprocessing unit 12 performs preprocessing for data acquired from the inspection device or a sensor mounted on the inspection device, data acquired by use or conversion of the data, or the like, and outputs the preprocessed data to the state observation unit 22. The preprocessing unit 12 acquires data indicating a factor in a machined-surface defect in a workpiece, from an input unit (not illustrated), performs necessary preprocessing for the data, and outputs the preprocessed data to the label data acquisition unit 24.

The preprocessing which the preprocessing unit 12 performs in order to acquire the state variable S includes various publicly-known processes for evaluating surface roughness Sa, surface maximum height Sv, surface texture aspect ratio Str, kurtosis Sku, skewness Ssk, developed interfacial area ratio Sdr, light reflectance on the machined workpiece, an image feature of the machined surface, or the like, for instance. The preprocessing which the preprocessing unit 12 performs in order to acquire the label data L includes generation of identification data for the factor in the machining defect that can be identified from various sensor data, input and analysis of a file in which a result of estimation of the factor in the machined-surface defect by a skilled operator is recorded, acquisition and analysis of the result of estimation of the factor in the machined-surface defect by the skilled operator that is directly inputted through an interface such as a keyboard, and the like, for instance.

The processing by the preprocessing unit 12 of generating the identification data for the factor in the machining defect that can be identified from various sensor data will be described. When a machined-surface defect occurs, the preprocessing unit 12 is capable of acquiring sensor data that is estimated as the factor in the machined-surface defect and converting the acquired sensor data into the identification data suitable for machine learning. The preprocessing unit 12 previously retains criteria for sorting of temperatures of cutting fluid into a plurality of levels and, in case where a problem exists in the temperature of the cutting fluid, generates the identification data indicating to what level the sensor data corresponds, for instance. Alternatively, the preprocessing unit 12 may generate binary identification data indicating that the temperature of the cutting fluid is excessively high or excessively low. The preprocessing unit 12 may output the identification data indicating material of a tool. Alternatively, the preprocessing unit 12 may generate binary identification data indicating that the tool is excessively hard or excessively soft. Furthermore, the preprocessing unit 12 may generate the identification data indicating a machining condition (such as magnitude of a rotational speed of a spindle and magnitude of a feed speed (synthetic speed)), degree or magnitude of machine vibrations, degree or magnitude of peripheral device vibrations, presence or absence of other disturbances, or the like.

The state observation unit 22 may be configured as a function of a CPU of a computer or may be configured as software for making a CPU of a computer function, for instance. As the numerical data that is the state variable S to be observed by the state observation unit 22, data indicating an inspection result on a machined surface may be used, for instance. The data includes data processed by the preprocessing unit 12 for the data acquired from the inspection device or a sensor provided on the inspection device and the data acquired by use or conversion of the data.

The state variable S may include identification data that indicates a location on a workpiece where a machined-surface defect has occurred and that will be described later. Thus a relationship between the inspection result on the machined surface from the inspection device and the occurrence factor of machined-surface defect can be learned independently for each location. Even if occurrence factors of a machined-surface defect differ among locations, consequently, an appropriate occurrence factor of machined-surface defect that corresponds to the inspection result on the machined surface from the inspection device can be outputted.

The label data acquisition unit 24 may be configured as a function of a CPU of a computer or may be configured as software for making a CPU of a computer function, for instance. As the label data L that is acquired by the label data acquisition unit 24, the data that has been preprocessed by the preprocessing unit 12 may be used. In case where the occurrence factor of machined-surface defect can be estimated from the sensor data, the identification data indicating a state of the sensor data is used, and in case where the occurrence factor of machined-surface defect is estimated by a skilled operator, the identification data indicating the estimated factor is used, for instance. The label data L indicates the occurrence factor of a machined-surface defect under the state variable S.

During learning by the machine learning device 20 included in the machining defect factor estimation device 10, machining by a machine tool, an inspection on a machined-surface defective workpiece by the inspection device, and estimation work for the occurrence factor of machined-surface defect are carried out in the environment.

The learning unit 26 may be configured as a function of a CPU of a computer or may be configured as software for making a CPU of a computer function, for instance. The learning unit 26 learns the occurrence factor of a machined-surface defect in accordance with a desired learning algorithm that is generically referred to as machine learning. The learning unit 26 is capable of iteratively executing the learning that is based on a data set including the state variable S and the label data L that relate to the inspection result on a machined-surface defective workpiece.

Iteration of such a learning cycle makes it possible for the learning unit 26 to automatically identify a characteristic that implies the correlation between the inspection results from the inspection device (the numerical data acquired from the inspection device) and the occurrence factors of machined-surface defects in the workpieces from which the inspection results have been acquired. Though the correlation between the inspection results from the inspection device and the occurrence factors of the machined-surface defects is substantially unknown at a start of the learning algorithm, the learning unit 26 interprets the correlation by gradually identifying the characteristic that represents the correlation as the learning advances. When the correlation between the inspection results from the inspection device and the occurrence factors of the machined-surface defects is interpreted to a level that is reliable to a certain degree, results of the learning that are iteratively outputted by the learning unit 26 are made usable for behavior selection (that is, decision making) as to how the occurrence factor of machined-surface defect is to be determined in relation to a current inspection result. That is, by the learning unit 26, the correlation between the inspection result from the inspection device and behavior as to how the occurrence factor of machined-surface defect is to be determined can be gradually made closer to an optimal solution with advance in the learning algorithm.

In the machine learning device 20 included in the machining defect factor estimation device 10, as described above, the learning unit 26 learns the occurrence factor of machined-surface defect that corresponds to the inspection result from the inspection device, in accordance with the machine learning algorithm with use of the state variable S observed by the state observation unit 22 and the label data L acquired by the label data acquisition unit 24. The state variable S consists of data hardly influenced by disturbance, that is, an inspection result of a inspection device. The label data L is unambiguously found based on declared data on the occurrence factor of machined-surface defect. According to the machine learning device 20 included in the machining defect factor estimation device 10, with use of the results of the learning by the learning unit 26, therefore, determination on the occurrence factor of machined-surface defect that corresponds to the inspection result from the inspection device can be made automatically and accurately without calculation or estimation.

Provided that the determination on the occurrence factor of machined-surface defect can be made automatically without calculation or estimation, the occurrence factor of a machined-surface defect on a workpiece can be promptly estimated only by the inspection in the inspection device after the machining of the workpiece by a machine tool. As a result, time taken for the determination on the occurrence factor of machined-surface defect can be shortened. Additionally, the operator is enabled to easily do tuning for improving quality of machined surfaces or the like.

In a modification of the machine learning device 20 included in the machining defect factor estimation device 10, the learning unit 26 may use the state variable S and the label data L that are acquired for each of a plurality of inspection devices and may thereby learn the occurrence factor of a machined-surface defect that corresponds to the inspection result from each of the inspection devices. According to this configuration, in which a quantity of the data sets including the state variables S and the label data L that can be acquired within a given period can be increased, a speed, reliability, and the like of the learning of the occurrence factors of the machined-surface defects that corresponds to the inspection results from the inspection devices can be improved with more diverse data sets used as input.

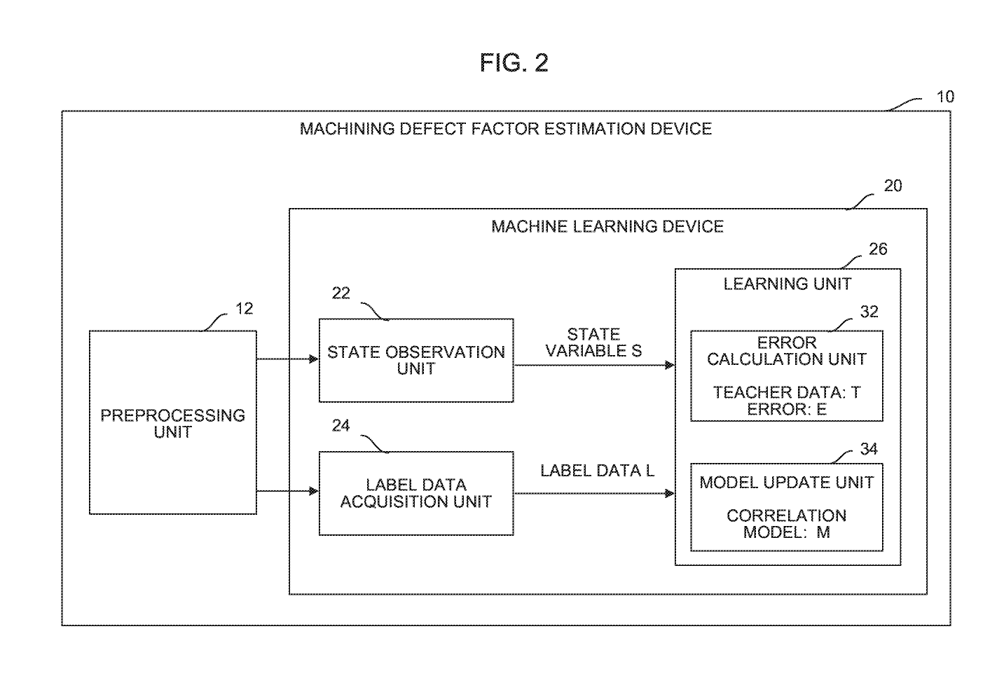

In the machine learning device 20 having the above configuration, there is no particular limitation on the learning algorithm that is executed by the learning unit 26 and a learning algorithm that is publicly known for machine learning may be employed. FIG. 2 illustrates a mode of the machining defect factor estimation device 10 illustrated in FIG. 1 and a configuration that includes the learning unit 26 which carries out supervised learning as an example of the learning algorithm.

The supervised learning is a technique in which a large amount of known data sets (referred to as teacher data) of input and corresponding output are provided in advance and in which a correlation model for estimation of necessary output for fresh input (the occurrence factor of machined-surface defects that corresponds to the inspection result from the inspection device in the machine learning device 20 according to the present invention) is learned by identification of a characteristic that implies a correlation between the input and the output from the teacher data.

In the machine learning device 20 included in the machining defect factor estimation device 10 illustrated in FIG. 2, the learning unit 26 includes an error calculation unit 32 that calculates an error E between a correlation model M for derivation of the occurrence factor of machined-surface defect from the state variable S and a correlation characteristic identified from teacher data T prepared in advance and a model update unit 34 that updates the correlation model M so as to reduce the error E. The learning unit 26 learns the occurrence factors of the machined-surface defects that correspond to the inspection results from the inspection device, with iterative updates of the correlation model M by the model update unit 34.

The correlation model M can be constructed through regression analysis, reinforcement learning, deep learning, or the like. An initial value of the correlation model M is given to the learning unit 26 before a start of the supervised learning, as a simplified expression of the correlation between the state variables S and the occurrence factors the machined-surface defects, for instance. The teacher data T can be composed of experience values (known data sets of the inspection results from the inspection device and the occurrence factors of machined-surface defects) accumulated by recording of the occurrence factors of the machined-surface defects that correspond to the past inspection results from the inspection device, for instance, and is given to the learning unit 26 before the start of the supervised learning. The error calculation unit 32 identifies the correlation characteristic that implies the correlation between the inspection results from the inspection device and the occurrence factors of the machined-surface defects from the large amount of teacher data T given to the learning unit 26 and finds the error E between the correlation characteristic and the correlation model M corresponding to the state variable S in the current state. The model update unit 34 updates the correlation model M so as to reduce the error E in accordance with a predetermined update rule, f or instance.

In a subsequent learning cycle, the error calculation unit 32 uses the state variable S acquired from the inspection by the inspection device and the label data L that is the result of the evaluation by the observer in accordance with the updated correlation model M and thereby finds the error E with respect to the correlation model M corresponding to the state variable S and the label data L and then the model update unit 34 updates the correlation model M afresh. Thus the correlation between the current state of the environment (the inspection result from the inspection device) and the corresponding state determination (the occurrence factor of machined-surface defect) that was unknown is gradually clarified. In other words, with the updates of the correlation model M, a relationship between the inspection result from the inspection device and the occurrence factor of machined-surface defect is gradually made to approach the optimal solution.

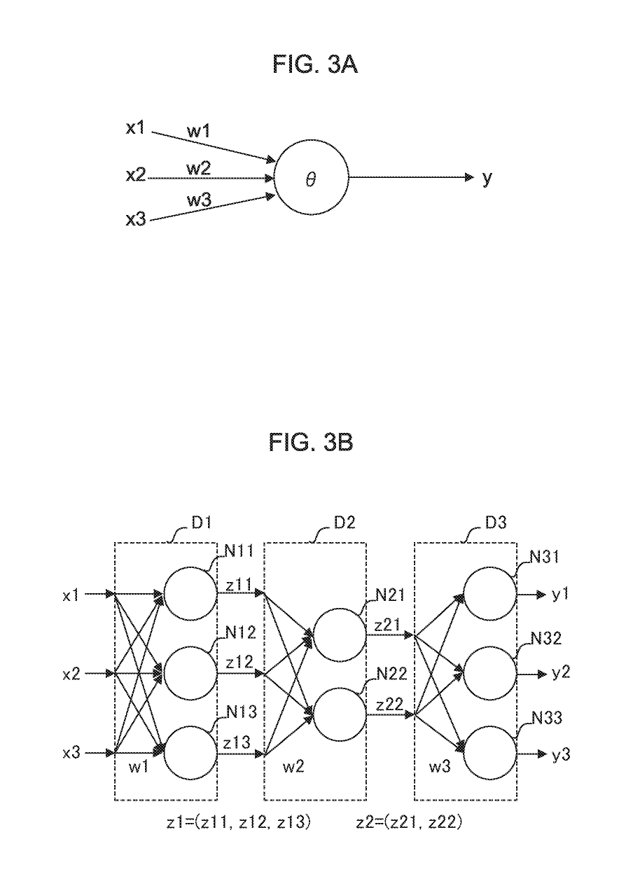

For the supervised learning described above, a neural network may be used, for instance. FIG. 3A schematically illustrates a model of neurons. FIG. 3B schematically illustrates a model of a three-layer neural network configured by combination of the neurons illustrated in FIG. 3A. The neural network may be configured with use of arithmetic units, storage devices, and the like that simulate the model of a neuron, for instance.

The neurons illustrated in FIG. 3A output a result y with respect to a plurality of inputs x (inputs x₁ to x₃, as an example). The inputs x₁ to x₃ are multiplied by weights w (w₁ to w₃) corresponding to the inputs x. Thus the neurons output the output y expressed by equation (1) below. In equation (1), all of the inputs x, the output y, and the weights w are vectors. θ is a bias and is an activating function.

y=fₖ(Σᵢ₌₁ⁿxᵢwᵢ−θ) (1)

In the three-layer neural network illustrated in FIG. 3B, a plurality of inputs x (inputs x1 to x3, as an example) are inputted from a left side and results y (results y1 to y3, as an example) are outputted from a right side. In an example illustrated in FIG. 3B, the inputs x1, x2, and x3 are respectively multiplied by corresponding weights (generically represented as w1) and the inputs x1, x2, and x3 are each inputted into three neurons N11, N12, and N13.

In FIG. 3B, outputs from the neurons N11 to N13 are generically represented as z1. z1 can be regarded as feature vectors in which feature amounts of the input vectors are extracted. In the example illustrated in FIG. 3B, the feature vectors z1 are respectively multiplied by corresponding weights (generically represented as w2) and are each inputted into two neurons N21 and N22. The feature vectors z1 represent features between the weights w1 and the weights w2.

In FIG. 3B, outputs from the neurons N21 and N22 are generically represented as z2. z2 can be regarded as feature vectors in which feature amounts of the feature vectors z1 are extracted. In the example illustrated in FIG. 3B, the feature vectors z2 are respectively multiplied by corresponding weights (generically represented as w3) and are each inputted into three neurons N31, N32, and N33. The feature vectors z2 represent features between the weights w2 and the weights w3. Lastly, the neurons N31 to N33 respectively output the results y1 to y3.

In the machine learning device 20 included in the machining defect factor estimation device 10, the learning unit 26 may carry out calculations of a multi-layer structure pursuant to the above-described neural network with the state variable S used as the inputs x, so that the occurrence factor (result y) of a machined-surface defect can be outputted. Operation modes of the neural network include a learning mode and a determination mode. The weights w can be learned with use of the learning data sets in the learning mode and the determination on the occurrence factor of machined-surface defect can be made with use of the learned weights w in the determination mode, for instance. In the determination mode, detection, classification, inferencing, and the like can also be carried out.

The configuration of the above-described machining defect factor estimation device 10 can be described as a machine learning method (or software) that is executed by a CPU of a computer. The machine learning method is a machine learning method of learning the occurrence factor of machined-surface defects that corresponds to the inspection result from the inspection device, and includes:

a step of making the CPU of the computer observe the state variable S that indicates the inspection result from the inspection device;

a step of acquiring the label data L that indicates the occurrence factor of machined-surface defect; and

a step of learning the inspection result from the inspection device and the occurrence factor of machined-surface defect in a manner such that they are correlated each other, with use of the state variable S and the label data L.

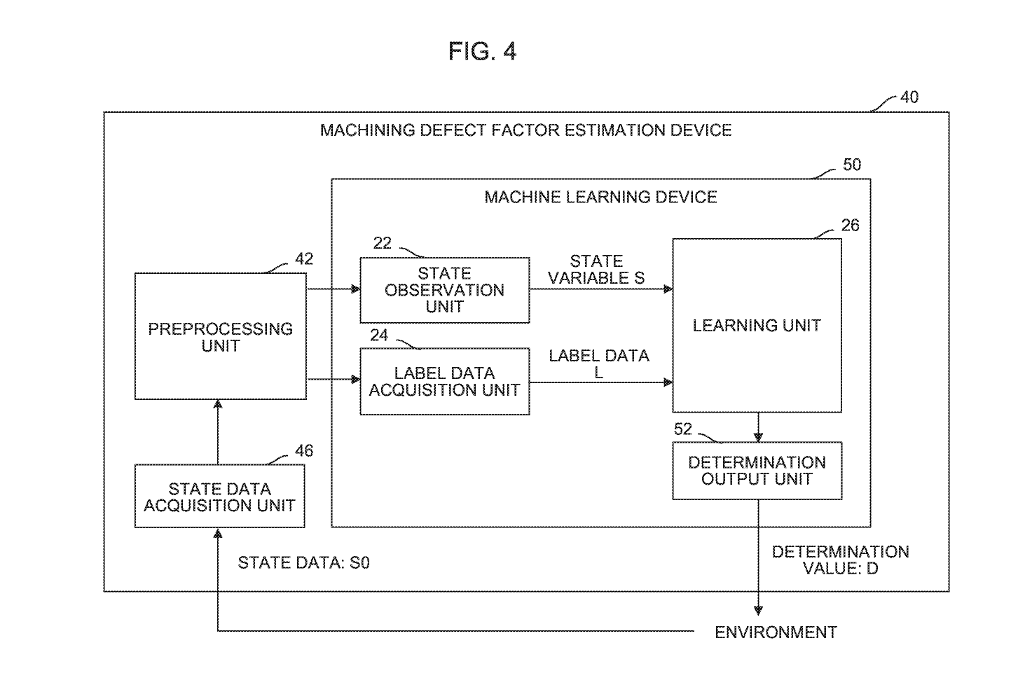

FIG. 4 illustrates a machining defect factor estimation device 40 according to a second embodiment. The machining defect factor estimation device 40 includes a preprocessing unit 42, a machine learning device 50, and a state data acquisition unit 46. The state data acquisition unit 46 acquires data to be inputted into the preprocessing unit 42, as state data S0, from an inspection device, sensors provided on the inspection device, or appropriate data input by an operator.

The machine learning device 50 included in the machining defect factor estimation device 40 includes software (such as an arithmetic algorithm) and hardware (such as a CPU of a computer) for output of the occurrence factor of machined-surface defect, determined by the learning unit 26 based on the inspection result from the inspection device, as display of characters on a display (not illustrated), output of sounds or voice from a speaker (not illustrated), output through an alarm lamp (not illustrated), or combination thereof, in addition to the software (such as the learning algorithm) and the hardware (such as a CPU of a computer) for the self-learning through the machine learning on the occurrence factors of the machined-surface defects that correspond to the inspection results from the inspection device. The machine learning device 50 may have a configuration in which one common CPU executes all software such as the learning algorithm and the arithmetic algorithm.

A determination output unit 52 may be configured as a function of a CPU of a computer or may be configured as software for making a CPU of a computer function, for instance. The determination output unit 52 outputs instructions to notify the operator of the occurrence factor of machined-surface defect, determined by the learning unit 26 based on the inspection result from the inspection device, as the display of characters, the output of sounds or voice, the output through the alarm lamp, or combination thereof. The determination output unit 52 may output the instructions for notification to a display or the like included in the machining defect factor estimation device 40 or may output the instructions for the notification to a display or the like included in the inspection device.

The machine learning device 50 included in the machining defect factor estimation device 40 having an above configuration achieves effects equivalent to effects of the machine learning device 20 described above and illustrated in FIGS. 1 and 2. Additionally, the machine learning device 50 illustrated in FIG. 4 is capable of changing a state of the environment by output from the determination output unit 52. In the machine learning device 20, on the other hand, a function equivalent to the determination output unit for reflection of the results of the learning by the learning unit 26 in the environment may be sought in an external device (such as a controller for the machine tool).

In a modification of the machining defect factor estimation device 40, the determination output unit 52 may set a predetermined condition for each of the occurrence factors of machined-surface defects that are determined by the learning unit 26 based on the inspection results from the inspection device and may output information as a warning in case where the occurrence factor of machined-surface defect that is determined by the learning unit 26 based on the inspection result from the inspection device complies with the condition.

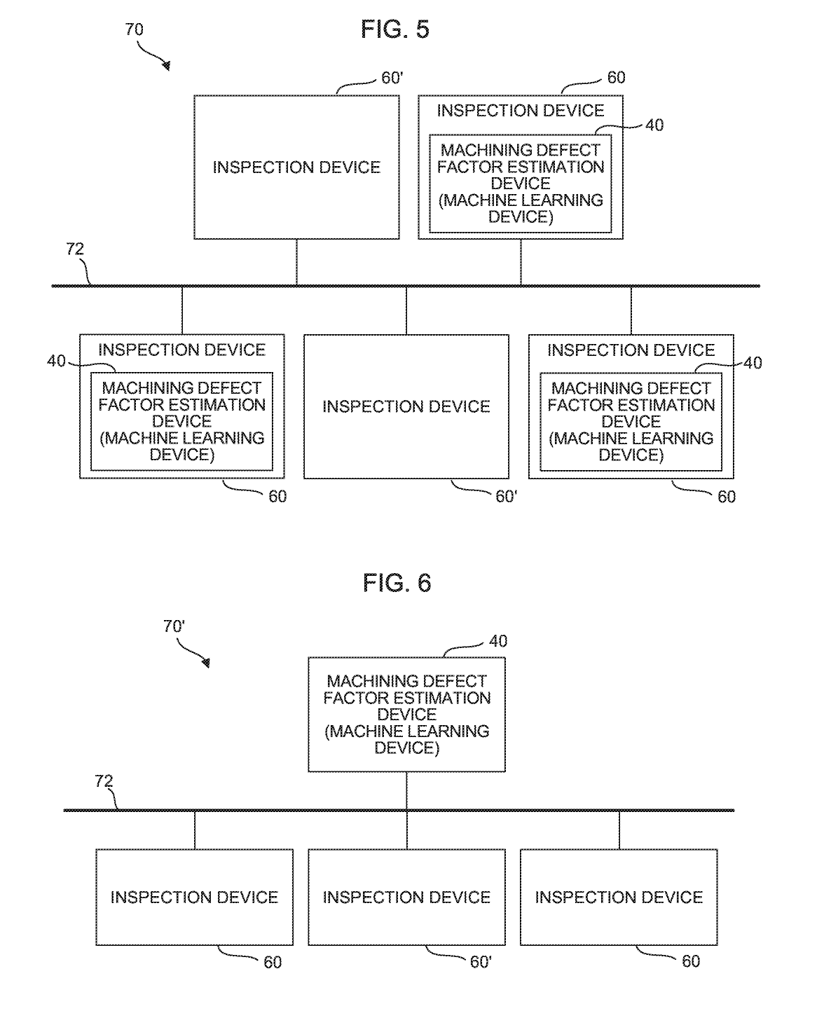

FIG. 5 illustrates a machining defect factor estimation system 70 according to an embodiment that includes inspection devices 60.

The machining defect factor estimation system 70 includes a plurality of inspection devices 60, 60′ that are capable of conducting an inspection with similar contents and accuracy and a network 72 that connects the inspection devices 60, 60′. At least one of the plurality of inspection devices 60, 60′ is configured as the inspection device 60 that includes the above-described machining defect factor estimation device 40. The machining defect factor estimation system 70 may include the inspection device 60′ that does not include the machining defect factor estimation device 40. The inspection devices 60, 60′ have an ordinary configuration necessary for an inspection of machined-surface quality of a machined workpiece.

In the machining defect factor estimation system 70 having an above configuration, the inspection devices 60 each including the machining defect factor estimation device 40, among the plurality of inspection devices 60, 60′, are capable of automatically and accurately finding the occurrence factor of machined-surface defect that corresponds to the inspection result from the inspection device 60 with use of the result of the learning by the learning unit 26 without calculation or estimation. The machining defect factor estimation device 40 of at least one inspection device 60 may be configured to learn the occurrence factor of machined-surface defect corresponding to the inspection results from the inspection devices 60, 60′ that is common to all the inspection devices 60, 60′, based on the state variable S and the label data L that are acquired for each of the plurality of other inspection devices 60, 60′ and all the inspection devices 60, 60′ may be configured to share a result of such learning. According to the machining defect factor estimation system 70, consequently, the speed, reliability, and the like of the learning of the occurrence factors of machined-surface defects that correspond to the inspection results from the inspection devices can be improved with use of more diverse data sets (including the state variables S and the label data L) as the input.

FIG. 6 illustrates a machining defect factor estimation system 70′ according to another embodiment that includes the inspection devices 60′.

The machining defect factor estimation system 70′ includes the machining defect factor estimation device 40 (or 10), the plurality of inspection devices 60′ that are capable of conducting an inspection with the same contents and accuracy, and the network 72 that connects the inspection devices 60′ and the machining defect factor estimation device 40 (or 10).

In the machining defect factor estimation system 70′ having an above configuration, the machining defect factor estimation device 40 (or 10) learns the occurrence factor of machined-surface defect that corresponds to the inspection results from the inspection devices common to all the inspection devices 60′, based on the state variable S and the label data L that are acquired for each of the plurality of inspection devices 60′, and thus the occurrence factor of machined-surface defect that corresponds to the inspection results from the inspection devices can be automatically and accurately found with use of results of such learning without calculation or estimation.

The machining defect factor estimation system 70′ may have a configuration in which the machining defect factor estimation device 40 (or 10) exists in a cloud server prepared in the network 72. According to this configuration, a necessary number of inspection devices 60′ can be connected to the machining defect factor estimation device 40 (or 10) when necessary, irrespective of places where and periods when the plurality of inspection devices 60′ exist.

Operators who engage in the machining defect factor estimation system 70, 70′ may make determination as to whether an attainment level of the learning by the machining defect factor estimation device 40 (or 10) of the occurrence factors of machined-surface defects that correspond to the inspection results from the inspection devices has reached a request level or not, at appropriate time after a start of the learning by the machining defect factor estimation device 40 (or 10).

In a modification of the machining defect factor estimation system 70, 70′, the machining defect factor estimation device 40 may be implemented so as to be integrated in a management device 80 that manages the inspection devices 60, 60′.

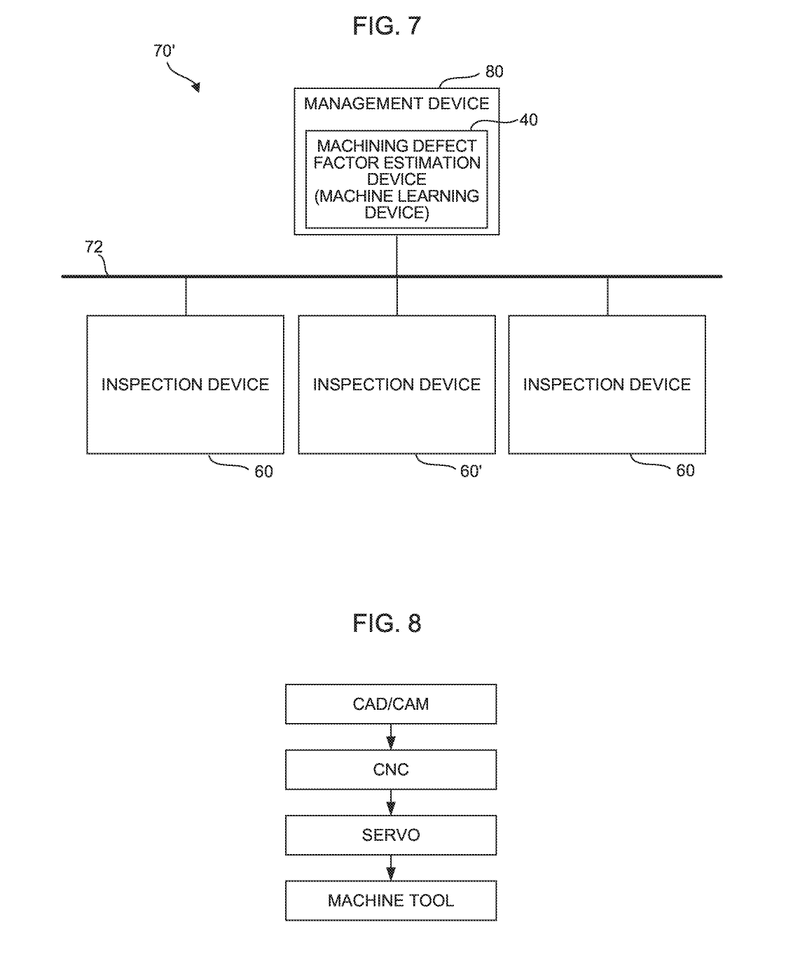

As illustrated in FIG. 7, the plurality of inspection devices 60, 60′ are connected to the management device 80 through the network 72 and the management device 80 collects data relating to operating conditions, the inspection results, and the like in the inspection devices 60, 60′ through the network 72. The management device 80 may receive information from desired inspection devices 60, 60′, may instruct the machining defect factor estimation device 40 to determine the inspection results from the inspection devices 60, 60′, and may output results of such determination onto a display provided in the management device 80 or the like or to the inspection devices 60, 60′ subjected to the determination. Such a configuration makes it possible to unify management of the results of the determination on the inspection devices 60, 60′ and the like in the management device 80 and to collect the state variables to be samples from the plurality of inspection devices 60, 60′ in relearning and thus has an advantage in that a large amount of data for the relearning can be easily collected.

Though the embodiments of the invention have been described above, the invention is not limited to the embodiments described above and can be embodied in various manners with appropriate modification.

For instance, the learning algorithms that are executed by the machine learning devices 20, 50, the arithmetic algorithm that is executed by the machine learning device 50, control algorithms that are executed by the machining defect factor estimation devices 10, 40, and the like are not limited to the above and various algorithms may be employed.

Though the preprocessing unit 12 is provided on the machining defect factor estimation device 40 (or the machining defect factor estimation device 10) in the above-described embodiments, the preprocessing unit 12 may be provided on the inspection device. Therein, the preprocessing may be carried out in either of the machining defect factor estimation device 40 (or the machining defect factor estimation device 10) or the inspection device or may be carried out in both. Sites for the processing may be appropriately set in consideration of processing capacity and communication speed.

Though the examples in which the learning unit 26 uses the algorithm of the supervised learning have been mainly described for the above-described embodiments, the invention is not limited to the examples. For instance, the state observation unit 22 may be configured to input only the inspection results on workpieces for which occurrence of a machined-surface defect due to a specific factor is estimated, as the state variable S, and the learning unit 26 may be configured to form a cluster that represents a feature of the inspection results on the workpieces for which the occurrence of the machined-surface defect due to the specific factor is estimated, pursuant to an unsupervised learning algorithm. In this example, the learning unit 26 may determine whether the inspection result from the inspection device on a machining defective workpiece that has newly occurred belongs to the cluster or not and may thereby estimate whether the machining defective workpiece has occurred due to the specific factor or not. Whether an inspection result belongs to the cluster or not can be determined based on a threshold determination on a distance from a center of the cluster or the like, for instance.

In this technique, learning processes may be made independent for each object location, for instance. That is, the learning may be carried out with use of a different learning unit 26 for each object location. Thus a different cluster is formed for each object location, so that the relationship between the inspection results from the inspection device and the occurrence factors of machined-surface defects can be learned independently for each object location. Even if the occurrence factors of a machined-surface defect differ among object locations, consequently, an appropriate occurrence factor of machined-surface defect that corresponds to the inspection result from the inspection device can be outputted.

1. A machining defect factor estimation device that determines an occurrence factor of a machined-surface defect, based on an inspection result on a machined surface of a workpiece from an inspection device, the machining defect factor estimation device comprising:
a machine learning device that learns the occurrence factor of the machined-surface defect which corresponds to the inspection result from the inspection device, wherein
the machine learning device includes
a state observation unit that observes the inspection result on the machined surface of the workpiece from the inspection device, as a state variable,
a label data acquisition unit that acquires label data indicating the occurrence factor of the machined-surface defect, and
a learning unit that learns the state variable and the label data in a manner such that they are correlated each other.

2. The machining defect factor estimation device according to claim 1, wherein the learning unit includes
an error calculation unit that calculates an error between a correlation model for determination on the occurrence factor of the machined-surface defect from the state variable and a correlation characteristic identified from teacher data prepared in advance, and
a model update unit that updates the correlation model so as to reduce the error.

3. The machining defect factor estimation device according to claim 1, wherein the learning unit carries out calculations of the state variable and the label data in a multi-layer structure.

4. The machining defect factor estimation device according to claim 1, further comprising:
a determination output unit that outputs the occurrence factor of the machined-surface defect which is determined based on a result of learning by the learning unit.

5. The machining defect factor estimation device according to claim 4, wherein the determination output unit outputs a warning in case where the occurrence factor of the machined-surface defect that is determined by the learning unit complies with a preset condition.

6. The machining defect factor estimation device according to claim 1, wherein the inspection result on the machined surface of the workpiece from the inspection device is a value acquired with use of at least one of surface roughness Sa, surface maximum height Sv, surface texture aspect ratio Str, kurtosis Sku, skewness Ssk, developed interfacial area ratio Sdr, light reflectance, and an image feature of the workpiece.

7. The machining defect factor estimation device according to claim 1, wherein the inspection device is made to carry out a predetermined operation for determination on the occurrence factor of the machined-surface defect by the learning unit.

8. The machining defect factor estimation device according to claim wherein the predetermined operation for the determination is carried out automatically or in response to a request from an operator.

9. The machining defect factor estimation device according to claim 1, wherein the machining defect factor estimation device is configured as a portion of the inspection device.

10. The machining defect factor estimation device according to claim 1, wherein the machining defect factor estimation device is configured as a portion of a management device that manages a plurality of the inspection devices through a network.

11. A machining defect factor estimation device that determines an occurrence factor of a machined-surface defect, based on an inspection result on a machined surface of a workpiece from an inspection device, the machining defect factor estimation device comprising:
a model that represents a correlation between the inspection result on the machined surface of the workpiece from the inspection device and label data that indicates the occurrence factor of the machined-surface defect; and
a determination output unit that outputs the occurrence factor of the machined-surface defect which is determined based on the model.
